(19) United States
(12) Patent Application Publication
(10) Pub. No.: US 2016/0104221 A1
(43) Pub. Date: Apr. 14, 2016

(54) SYSTEM AND METHOD FOR ENABLING SELLERS TO CREATE AND MANAGE OFFERS TO SELL PRODUCTS OR SERVICES TO GROUP BUYERS FOR A DISCOUNTED PURCHASE PRICE

(71) Applicant: Vadim Zakusilo, Short Hills, NJ (US)

(72) Inventor: Vadim Zakusilo, Short Hills, NJ (US)

(73) Assignee: EBUYTS INC, New York, NY (US)

(21) Appl. No.: 14/509,149

(22) Filed: Oct. 8, 2014

(51) Int. Cl. G06Q 30/06

(52) U.S. Cl. CPC G06Q 30/0605

(57) ABSTRACT

A computer implemented system and method enables sellers to create and manage offers to sell products or services to group buyers for a discounted purchase price. The system and method also allows buyers to create buying groups independent of the sellers' offers for services or products. A buyer can register with the sale promoter and gain access to any number of offers to sell, the offers having discounted pricing, made by the seller. A typical offer to sell will have an expiration date, the quantity of items to be sold, and the price by which the items will be sold. By leveraging the power of group buying, the buyers can join a group formed by a seller or a buyer to receive a discounted price on an item. Further, buyers can rank one another thereby enabling or limiting access to certain groups to certain buyers.

### CLAIM OF PRIORITY

This application is claims no priority to any patent or patent application.

### FIELD OF THE EMBODIMENTS

This invention and its embodiments relate to a platform that facilitates the bringing together of multiple individuals to strengthen the individuals bargaining power, namely providing an interactive platform whereby sellers of goods and services can provide discounts to a group of buyers.

### BACKGROUND OF THE EMBODIMENTS

Group buying, also known as collective buying, offers products and services at significantly reduced prices on the condition that a minimum number of buyers would make the purchase. Origins of group buying can be traced to China, where people would get discount prices from a retailer when a large group of people were willing to buy the same item. In recent years, group buying websites have emerged with a major influence on the online shopping business. Typically, these websites feature a “deal of the day,” with the deal kicking in once a set number of people agree to buy the product or service. Buyers then print off a voucher to claim their discount at the retailer. Many of the group buying sites work by negotiating deals with local merchants and promising to deliver crowds in exchange for discounts.

Typically group buying works in one of two fashions: 1) fixed time period or so called “daily deals” where the group buying process has a fixed time period and 2) group buying at a fixed price that is reached contingent upon a certain number of committed buyers. In the late 1990s-early 2000s there were attempts to capitalize on this niche market. One of the most well-known was Mercata, an e-commerce start up, whose business model focused on dynamic pricing where the price would drop on an item with respect to how many people signed up to purchase the product. In the end, such a model failed to produce results as people could get better deals elsewhere.

Recently, there has been a resurgence in the group buying marketplace in the online community. Websites such as Groupon have found a foothold in the marketplace, but still have not tackled many problems in the group buying community. Groupon offers daily coupons which only become available after a certain number of committals from prospective customers. However, such a model has the potential to overwhelm a small company leading to unsatisfied consumers. Additionally, companies receive only 50% of the sale price of the coupon which, in many cases, does not turn to economic profits as the company receives a one-time surge in buyers and does not enable a new base to be established. Groupon is also selective in what offers they make available and estimates have placed an acceptance rate over just over 10% on pitches from sellers.

Thus, there is much room for improvement in the group buying models. As described above, many group buying based entities have gone out of business or have business models that are not conducive for enabling sellers of all shapes and sizes to provide a group buying based discount or build a loyal consumer base. There must be a system that can effectively place sellers in control of the group buying experience while creating a sustainable business model. The present invention and its embodiments meet and exceed these objectives.

### Review of Related Technology:

U.S. Pat. No. 8,732,018 pertains to a demand aggregation system that includes a deal room sponsored by a third party host. The third party host facilitates commercial transactions between a plurality of buyers and at least one seller. In exchange for sponsorship of such a deal room, the third party host can receive an incentive such as a percentage of sales, seller discount or the like. Furthermore, mechanisms are provided to aid discovery of sellers and/or offers that can be included in a group buying event for a buying group. The buying group receives a greater discount as the total purchase amount in the group buying event increases.

U.S. Pat. No. 8,712,864 pertains to a method and system that enable buyers and sellers to communicate with each other and to negotiate the purchase terms of featured merchandise in a group-buying opportunity. Sellers and buyers may use various forms of on-line group-buying mechanisms in conjunction with the negotiation features of the invention. Buyers may send various inquiries to sellers regarding merchandise offered for sale through the online group-buying sale. Sellers may respond to buyer questions and queries, and in some instances, sellers may communicate instructions to the on-line group-buying mechanism to alter the course of an on-line group-buying sale in progress, e.g., a further reduction in price. The method and system further provides a mechanism for calculating a demand curve based on received buyer offers and applying the demand curve to an on-line group-buying sale.

U.S. Pat. No. 8,266,002 pertains to a system to facilitate the interaction of a group of buyers and a group of sellers through a transaction network, such as the internet. A buyer may start a buying group or join an existing group for purchasing a product or service. During the life cycle of a buying group, buyers are encouraged to invite other buyers to join the group via email, blog, social networking websites, or other means, thereby increasing the purchasing power of that group. Once a buying group has been established, sellers can compete for the volume sale. Sellers may review the bid price submitted by other sellers and submit competing bids. Once the bid cycle closes this system will automatically match the buyers and sellers based on a variety of factors including the order each buyer entered his or her purchase intent, each buyer's maximum price, each seller's bidding price, the quantity each seller can provide, and the order of each seller's bid. At the end of the matching, one or more sellers may fulfill a single group order.

Various devices are known in the art. However, their structure and means of operation are substantially different from the present disclosure. The other inventions also fail to solve all the problems taught by the present disclosure. The present invention transfers the power from the intermediaries or consumers to the seller of the products or services. Further, the system and methodology provides for a sustainable business model. At least one embodiment of this invention is presented in the drawings below and will be described in more detail herein.

### SUMMARY OF THE EMBODIMENTS

A computer implemented method is performed via a processor for enabling at least one seller to create and manage at least one offer to sell products or services to a plurality of buyers for a discounted purchase price is described and taught, the method having the steps of: the seller obtaining an electronic client code generated by a processor from a sale promoter, wherein the client code is placed on at least one electronic page where an offer to sell is being made, wherein the client code enables electronic communication with the sale promoter; at least one of the plurality of buyers making an offer via a processor to purchase a product associated with the electronic client code; wherein to make the offer the at least one buyer interacts with the client code and wherein to make the offer the at least one buyer must be registered with the sale promoter; comparing parameters of the offer with parameters implemented by the at least one seller; wherein the parameters include at least a minimum number of products subject to purchase, an offer price, and an expiration date, and wherein if the parameters of the offer meet the parameters implemented by the at least one seller then a sale is executed and if the parameters of the offer do not meet the parameters implemented by the at least one seller then the sale is not executed.

In another aspect of the invention there is a system that has at least one processor communicatively coupled to at least one computer readable storage medium, whereby the at least one processor is programmed to implement a group purchasing platform, the system having an audiovisual display for displaying and communicating the desired content; a computing device capable of being connected to a network; a computer readable storage medium storing one or more programs for execution by the computing device; and a processor operably coupled to the computing device, the processor configured to execute the steps of, a seller obtaining an electronic client code generated by the processor from a sale promoter, wherein the client code is placed on at least one electronic page where an offer to sell is being made, wherein the client code enables electronic communication with the sale promoter; at least one of a plurality of buyers making an offer via the processor to purchase a product associated with the electronic client code; wherein to make the offer the at least one buyer interacts with the client code and wherein to make the offer the at least one buyer must be registered with the sale promoter; comparing parameters of the offer with parameters implemented by the at least one seller; wherein the parameters include at least a minimum number of products subject to purchase, an offer price, and an expiration date, and wherein if the parameters of the offer meet the parameters implemented by the at least one seller then a sale is executed and if the parameters of the offer do not meet the parameters implemented by the at least one seller then the sale is not executed.

Generally, the present invention and its embodiments cover a computer implemented system and methodology directed towards group buying of products and services for a discounted price. The central piece of the system and methodology is the amalgamation provider software (APS). The APS acts as a conduit by facilitating transactions and linking buyers and sellers of goods and services.

The APS places offers to sell made by sellers on its electronic page or web page. Thus, buyers can make an offer to buy directly through the APS or through the seller's own page hosting the product or service. The APS provides a unique code to each seller's product or service that enables buyers to join the buying group from the seller's site.

In order to place a product or service for sale, the seller registers with the APS and receives a client code that is placed on the seller's website. The seller then sets the price, quantity, and expiration date. Other variables may also be set at the seller's discretion. Further, the seller can accept offers to buy, delete offers to sell, and close their account with the APS.

The buyer, once registered with the APS, can join a group buying offer to sell through any of the seller's own webpages or though the posting on the APS. Once engaged in an offer, the buyer may communicate with others in the buying group and rank others within the buying group based on their conduct amongst other variables. A buyer may also leave or quit from committing to an offer. In some instances, a buyer may create an offer to buy that is independent from an offer to sell made by a seller. In this case, the buyer will be able to print a certificate and approach a seller to potentially make a deal on bulk products and/or services.

In general, the present invention succeeds in conferring the following, and others not mentioned, benefits and objectives.

It is an object of the present invention to provide a system and method of conducting bulk sale of good and services.

It is an object of the present invention to provide a system and method that enables sellers of goods and services to find multiple buyers for a particular good and/or service.

It is an object of the present invention to provide a system and method that enables buyers to save money in making purchases on goods and services.

It is an object of the present invention to provide a system and method that enables buyers to rank one another to create stronger offers to buy from a seller.

It is an object of the present invention to provide a system and method that allows buyers to create offers to purchase independent of those made by the sellers.

It is another object of the present invention to provide a system and method that ensures buyers and sellers are authenticated and will comply with the offers made by the respective parties.

It is another object of the present invention to provide a system and method that creates a client code to identify an offer to sell made by a seller.

It is another object of the present invention to provide a system and method that requires buyers and sellers to finalize the sale of good and services once the terms of the offer to sell have been met.

### BRIEF DESCRIPTION OF THE DRAWINGS

FIG. 1 is a graphical depiction of a high level system overview of the present invention.

FIG. 2 is a graphical depiction of an example of an offer stored on the APS made in accordance with the present invention.

FIG. 3 is a graphical depiction of an example of a seller page made in accordance with the present invention.

FIG. 4 is a flowchart outlining the process of a buyer registration with the APS.

FIG. 5 is a flowchart outlining the process of a seller registration with the APS.

FIG. 6 is a flowchart outlining a methodology of using an embodiment of the present invention.

FIG. 7 is an example of a screen shot showing a product on a seller website featuring the clickable button on a seller web page.

FIG. 8 is an example of a screen shot showing the same product as shown on the APS webpage.

### DESCRIPTION OF THE PREFERRED EMBODIMENTS

A portion of the material in this patent document is subject to copyright protection under the copyright laws of the United States and/or other countries. The owner of such material has no objection to the facsimile reproduction by anyone of the patent document or the patent disclosure, as it appears in the United States Patent and Trademark Office publicly available file or records, but otherwise reserves all copyright rights whatsoever.

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

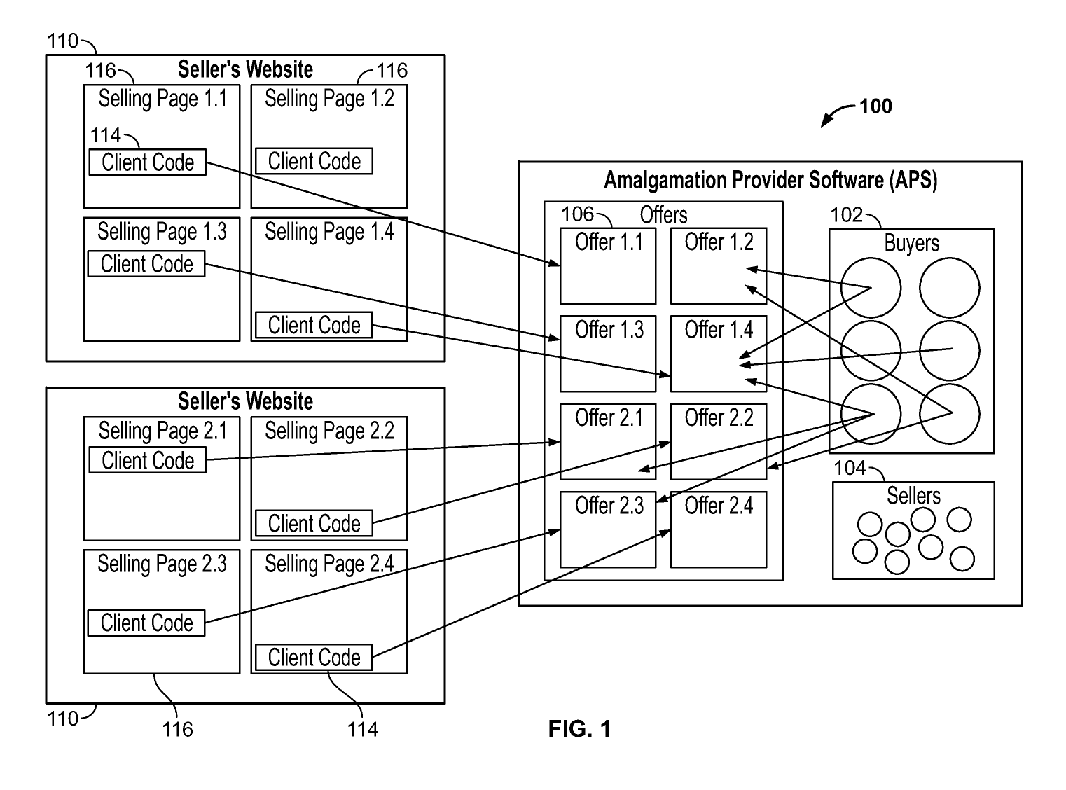

Referring now to FIG. 1, there is a high level overview of an implementation of the present invention. The system generally comprises an amalgamation software provider (APS) or sale promoter 100 and any number of sellers 104 and buyers 102 which can interface with the APS 100. The APS 100 provides a platform by which buyers 102 and sellers 104 of products and/or services can interact to obtain discounts for group buyers or buying groups.

In order to sell an item through the APS 100, a seller 104 registers with the APS 100. Contingent upon agreeing to and meeting the terms associated with the APS 100, the seller(s) 104 can become registered members enabling them to make at least one offer to sell an item such as a product or service. There are generally no restrictions on what products or services are to be sold except illegal items will not be permitted for sale or purchase.

After such an offer is to be made, the APS 100 provides the seller 104 with a snippet of code or a client code 114 to create a graphical representation of a clickable button on a seller website 110. The seller's website 110 may have any number of selling pages 116 which make an offer to sell an item. The client code 114 can be placed on any number of the selling pages 116 according to the product or service represented by the client code 114.

The client code 114 provides an interface and/or instructions for supplying the specific information required by the APS 100 to complete the offer to sell. The information required may include but is not limited to the products or services to be sold per offer, the offer price, the offer expiration (date), an identification of the products or services to be sold, and the uniform resource locator (URL) where the product or service is present on the seller website 110.

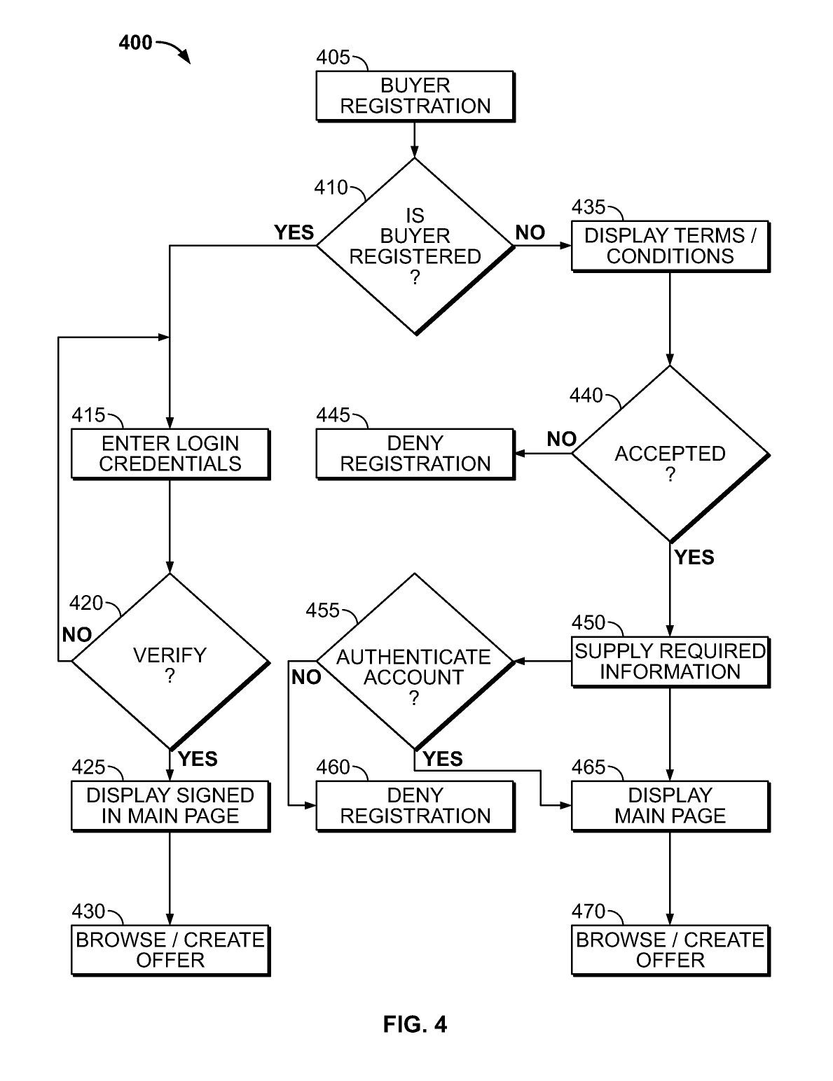

In turn, the client code 114 has a mechanism whereby a graphical depiction of a clickable button (by way of preferably html or drawing) is created and displayed on the selling page 116 associated with the input URL. The graphical representation of which will preferably contain at least the input offer price, the input offer quantity, and the committed buyer tally or count (see FIG. 3).

Once the client code 114 is propagated on a selling page 116, the client code 114 communicates with the APS 100 to at least register new offers 106 to be placed on the APS 100 interface and to transmit existing offers 106 characteristics between the selling page 116 and the APS 100. This results in the automatic and seamless compilation of offers on the APS 100 as they are made by a seller 104. As shown, the APS 100 may host any number of offers 106 at any given time which may link back to any number of a sellers 104.

The buyers 102 can interact with the offers 106 either through the APS 100 or the selling page 116. Thus, the buyers 102, can view any offer and once registered with the APS 100 can make commitments to purchase the products or services featured in any of the offers 106. If the buyer 102 accesses the offer 106 through the selling page 116 the buyer 102 may be redirected to the APS 100 via the clickable button 114. This allows for the APS 100 to maintain a listing of the products or services associated with a buyer 102, the commitments made by a buyer 102, recommend products or services for the buyer 102, and the like or any combination thereof. In some instances, the APS 100 will host “communities” of buyers 102 committed to a particular service or product that allows buyers to converse, publicly or privately amongst themselves, to rank the seller and other buyers, and perform various other interactive features.

In other instances, a buyer 102 can create an offer to purchase independent of such an offer being made by a seller 104. Thus, at least one buyer 102 can create an offer having a plurality of offer parameters. When the number of committals for a specified object/service for a reduced price is met, the buyer 102 is provided a certificate with a unique code. This certificate is printable or may reside solely on an electronic device. The unique code, when scanned by a standard bar code reader will supply the any and all information to the seller 104 pertaining to the particular of the offer. At this point, it is the discretion of the seller 104 if they wish to accept this offer. In the case when the seller accepts, they will be able to contact the buyer(s) and complete the transaction via any appropriate methodology.

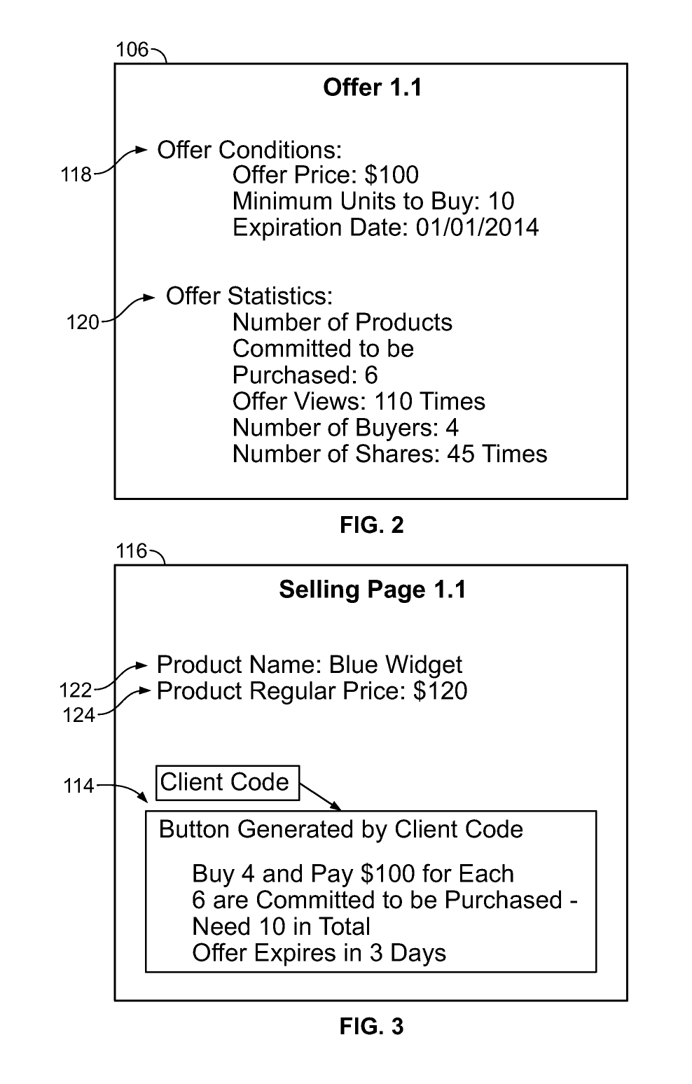

In FIG. 2 there is a view of an offer 106 as placed on the sale provider or APS 100. The offer 106 contains a number of variables including offer conditions 118 and offer statistics 120. The offer conditions 118 typically comprise the offer price, minimum units to buy, and the expiration date.

The offer price is the price set by the seller of the item. In some instances, the APS 100 may be able to set the offer price dependent on the relationship with the seller. The minimum units to buy is the lowest number of units to be bought to enable the discounted bulk sale of the item up for sale. The expiration date is the date on which the offer expires. Some offers will expire and be removed from the APS 100, whereas others will be reset to begin the selling cycle again in an attempt to garner the requisite interest. Other conditions may make the offer contingent of any number of variables that may need to be met singularly or in conjunction with one another to trigger certain events such as a sale.

The offer statistics 120 stored through the APS 100 typically comprises the number of products committed to be purchased, the number of views the offer has received, the number of buyers, and the number of times the offer has been shared. Such offer statistics may be available to only certain people (i.e. subscribed users) or may otherwise be shown in full or otherwise limited views. Statistics should be shown in real time and accurately reflect the interest or lack thereof in an item for sale.

The offers 106 may be grouped according to their origin (seller) or sortable by any number of criteria such as price, class, color, style, model, manufacturer, and the like or any combination thereof.

Referring now to FIG. 3, there is a graphical depiction of a selling page 116. The selling page 116 contains information typically seen on a webpage offering an item for sale. For example, the selling page 116 will typically have the product name 122 and the product price 124. The product name 122 identifying the product to be sold and the product price 124 being the regular, or full, price of the product or service being sold.

The client code 114 generates a clickable button which contains information related to the bulk purchase of the item described by the product name 122. The client code 114 has information input by the seller and contains variables such as the amount of products or services to be sold, the discounted price, the number of buyers committed to buying the product, and the expiration date. These variables are sent to the APS and stored thereon as shown in FIG. 2.

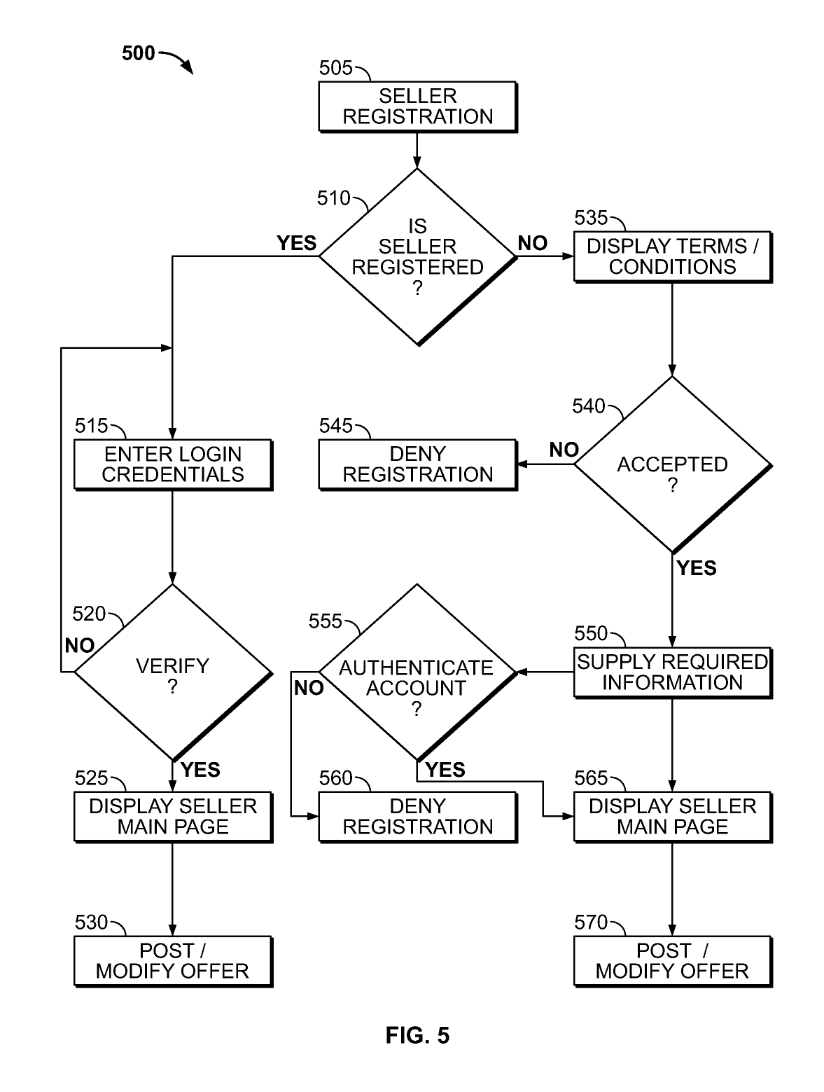

FIG. 4 illustrates the process or method 400 for a buyer to register with the APS or sales promoter. Upon visiting the APS, seller's website, selecting a clickable button associated with the APS, or selecting a product registered with the APS, the buyer is greeted with a registration/log-in prompt 405.

In step 410, the system checks to see if the buyer is registered. If the buyer is registered, the process moves to step 415. If the user is not registered, the process moves to step 435.

In step 415, the registered user is prompted for their log-in credentials which typically comprise a user name and password, but could be any type of identifying information including fingerprints or other biometrics. If the inputted credentials are incorrect, the user is re-prompted for entry. If the credentials match those stored in the system database, then a user is verified in step 420. In step 425, an electronic page, typically a home page or page associated with the user's account is displayed. This “signed in” status allows the user to access certain features and perform certain activities such as becoming part of a buyer group, ranking buyers/sellers, and modifying account settings.

In step 430, the buyer can browse and/or create offers for products or services. The created offers are made independent of the seller and encourage the buyer(s) to find a collective bargaining group or buying group to leverage the power of the group to receive a discount on a product or service.

In step 435, if the user has not previously registered with the APS, the terms and conditions as related to the APS are displayed upon creation of a user profile. A user must accept the terms and conditions of the APS in order to create an account and any potential user not accepting the terms and conditions will be denied registration as shown in step 445.

If, however, in step 440 the terms and conditions are accepted, a user can proceed to step 450 by supplying the requisite information including but not limited to name, address, city, state, zip code, age, sex, billing address(es), and shipping address(es). Some or all of the information may be required to create an account.

In step 455 the user must authenticate their account. This is done to ensure the user created account is a valid account attributable to a person who is the purported owner of the account. This authentication is done via a delivered SMS message, phone call, email, or the like or any combination thereof delivered to an electronic device of the user. After the authentication has been sent, a user must activate the account using a code or message contained in the authentication correspondence within a prescribed time limit or the account will not be allowed registration as shown in step 460.

In step 465, the account has been authenticated and the user is now greeted with the main page or a splash screen indicating the account has been verified and the user in step 470 can begin to browse or create offers through the APS or any selling site.

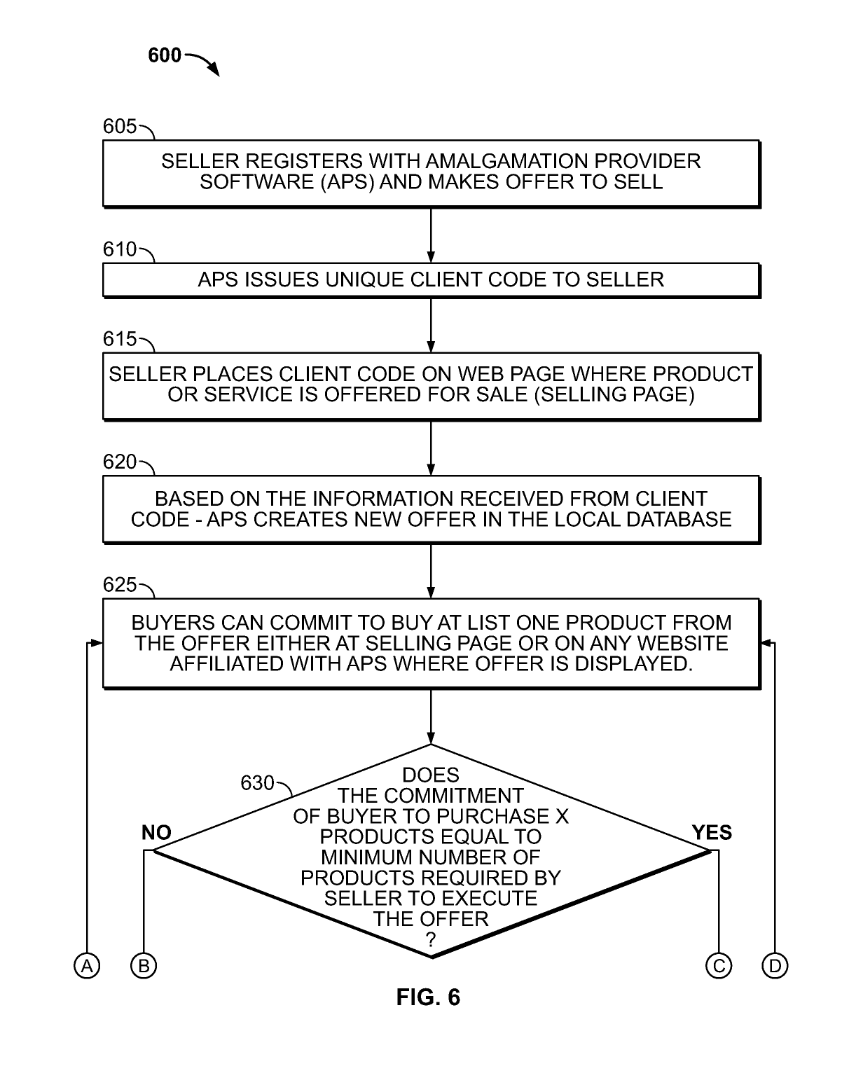

Referring now to FIG. 5, there is a process 500 for a seller to register with the APS or sale promoter. The process 500 begins in step 505 when a seller accesses the APS site. There may be one registration for both buyers and sellers or one may have to click on the designation they are interested in signing up for.

In step 510, the system checks if the seller is registered with the APS by prompting the seller to log-in to the APS site.

If a seller has a registered seller account the seller can log-in, in step 515, using their credentials which typically include a user name and a password but may also include biometrics or other positive identification identifiers. If the seller does not enter the correct credentials then the seller will be re-prompted to attempt to log-in again.

In a step 520, the seller is verified and brought to their main seller account page or any other page of the APS site in step 525.

In step 530, the seller may post or modify any offer that the seller has previously made. This includes withdrawing an offer or making any necessary modifications to an offer.

If the seller had not previously registered with the APS, then in step 535 the seller is prompted with specific terms and conditions geared towards the activation and maintenance of a seller account.

In step 540, if the seller accepts these terms and conditions, the seller can supply the requisite information in step 550 such as business name, location of incorporation, account numbers, physical location, and the like. If the seller does not accept the terms and conditions, then in step 545, the seller is denied registration.

In step 555, after receiving the required log-in information, the seller must authenticate their account. This is done to prevent fraud and ensure legitimate accounts are being opened. The authentication can occur by receiving a code which is entered into the APS to verify the authenticity of the entity. This code can be received by email, SMS, phone call, or the like or any combination thereof. Further authentication may need to be provided by way of identifying information such as a bank account or EIN number.

Once authenticated, the seller is brought to their selling account page in step 565 which permits the seller to post or modify offers in step 570. The selling account page can provide a seller with a one stop location to track, manage, modify, and distribute sold items.

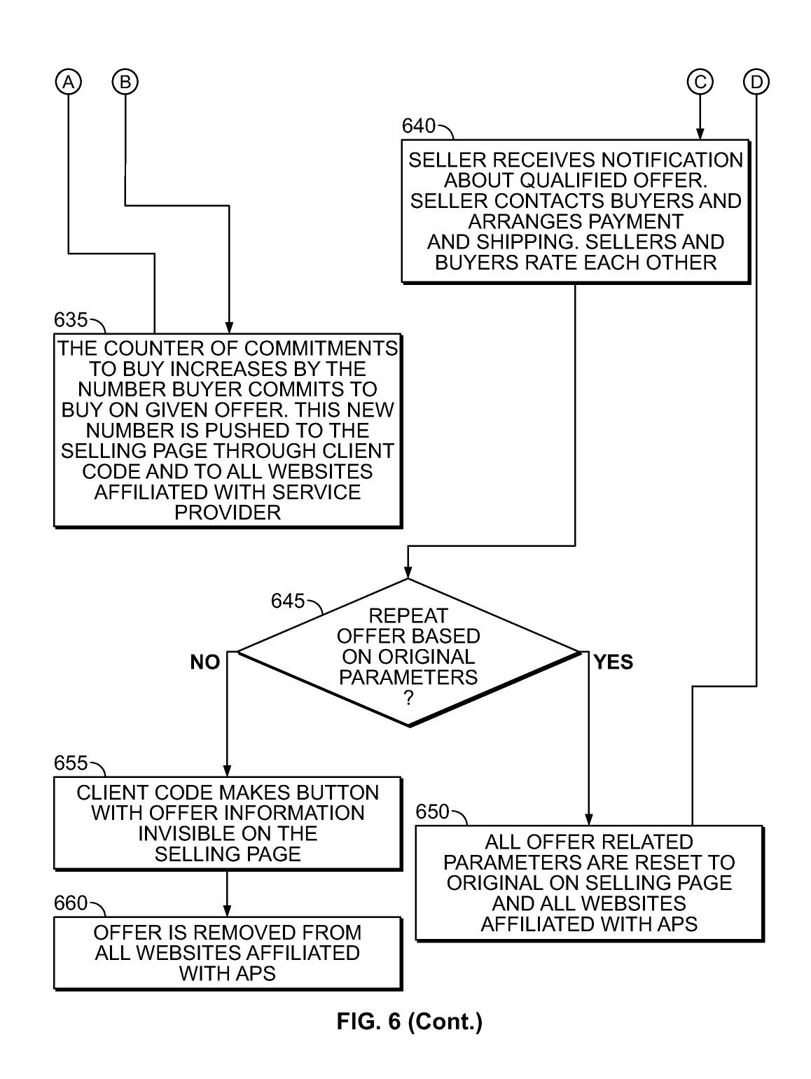

Now, in FIG. 6, there is a flowchart detailing the process of a selling posting an offer to sell and a buyer making a commitment to purchase the product or service from the seller according to the terms offered by the seller. In step 605, a seller registers or logs-in to the APS or sale promoter. When a seller desires to make a new offer of sale, the seller selects the post new sale option.

In step 610, the APS issues a unique client code to the seller.

In step 615, the seller places the client code on an electronic page where the item is being sold. The client code is populated with parameters related to the offer to sell the product or service. This is shown on the web page or electronic page through replaceable/dynamic tags. Further, the client code enables communication with the APS and send the parameters to the APS.

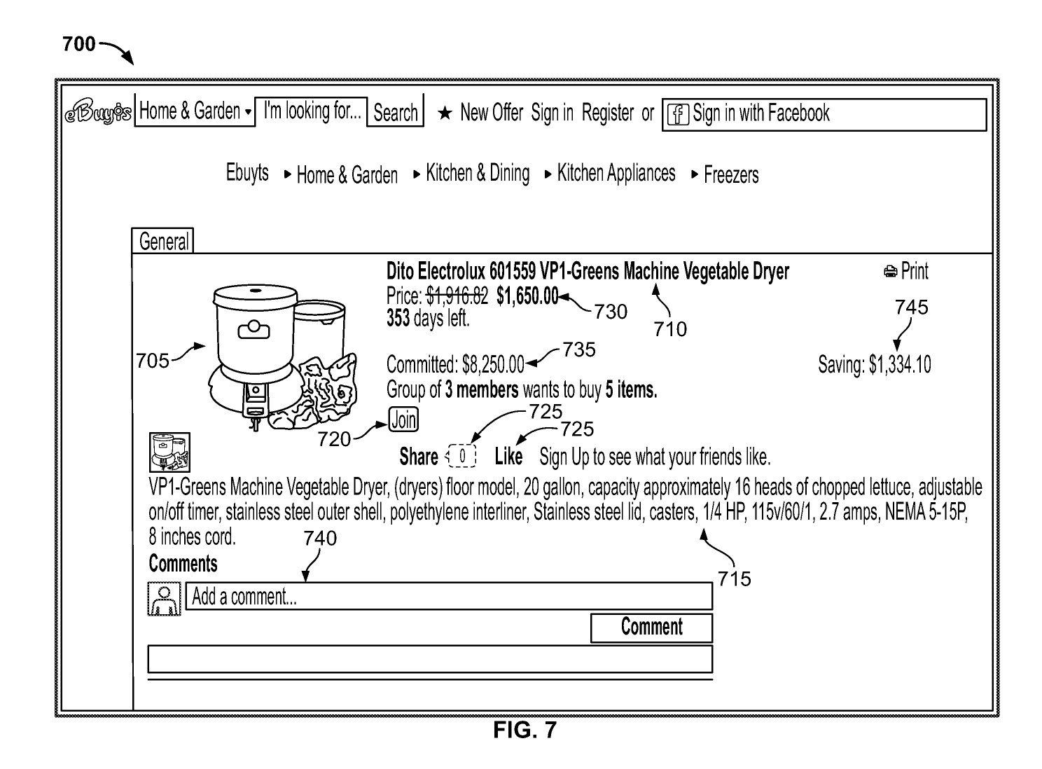

In step 620, the APS creates a new offer in its database based on the client code parameters received from the seller (see FIG. 7). The APS uses data associated with the client code to sort and place the offer on a selling page directly associated with the APS. The APS then returns information to the client code. The client code receives this information and then draws the button (clickable) on the selling page with information related to the offer. In some instances, the APS will then share the offer and its terms with an affiliated or unaffiliated website.

In step 625, any number of buyers can make a commitment to buy at least one product subject to an offer for sale through the selling page or through the APS directly. Additionally, such a commitment can be made through any other website where the offer is displayed. Once the buyer commits to make a purchase of at least one product or service, a system check is performed.

In step 630, the system checks to see if the committed number of products or services to be sold (including present commitment) is enough to fulfill the order subject to the parameters instituted by the seller.

If the minimum item threshold is not met, as shown in step 635, the real time counter on the web page changes to reflect the increase in the number of commitments based on this commitment. This causes a change in the client code and communication between the APS and other sites bearing a clickable offer to sell button are updated accordingly. This process continues until the minimum item threshold is met by buyer commitments to purchase.

In step 640, the minimum item threshold has been met. The seller then receives notification to this effect. The seller then arranges payment and shipping information with the buyers devoid of any assistance from the APS or sale promoter. At this point, the sellers and buyers may rate each other depending on each of the parties' perceived actions throughout the transaction process. This rating process may effect who can post an offer to sell or allow others to dictate who can join a buying group (i.e. seller can restrict the buying group to buyers with above a particular rating).

In step 645, the offer may be repeated based on the seller's parameters when setting up the initial offer to sell. Additionally, the seller may change these parameters at any time.

In step 650, the seller has decided to make a repeat offer to sell under the same parameters. The parameters, such as number of commitments, are reset and the clickable button is repopulated on the web page(s). Buyers can then begin making commitments as shown in step 625.

However, as shown in step 655, if the seller has decided to not make the same offer to sell, then the client code is permitted to make the button with the offer invisible on the selling page.

In step 660, the offer is then made invisible on all web sites associated with the seller or the APS.

Referring now to FIG. 7, there is an example screen shot of a selling page 700 as shown on the APS or sale promoter site. The selling page 700 prominently features a product or service image 705 and a product or service name 710. The product image 705 is an image or a set of images that show the product being sold by the seller. The seller may have to upload a picture that is then sent to the APS or the APS may be able to pull a picture from either a URL associated with the selling page or an image from an image database that correlates to the product being offered for sale. The product or service name 710 is simply the name of the product or service being sold.

A description 715 provides details and specification of exactly what one can expect to receive by making a commitment to purchase. This may include descriptors such as size, color, weight, and model. Pricing information 730 may be shown to indicate the savings a buyer will be receiving by making a committal. A discount price and a full or non-discount price will be placed by one another enabling the consumer to compare the two prices. A reduction indicator such as a percentage or dollar value saved may be included to provide a quick and easy reference for the consumer. This pricing information 730 is dependent on the seller's preferences and input into the client code.

The buying group information 735 preferably indicates the number of committed buyers, the amount of items being committed to purchase, and the total monies committed. Additionally, there may be a savings indicator 745 which shows either the individual savings, savings of the entire purchasing group, or a combination thereof.

Assuming a buyer is interested in receiving the product or service for a discount, a buyer can commit to making a purchase at a particular discounted or reduced price by clicking the join button 720. This puts the buyer into the purchasing group and enables the buyer to make comments via a text entry 740 in the purchasing group, the selling page, or the like. In some instances, there may be separate comment areas for committed buyers and non-committed buyers. Further, the social aspect of the buying process can be enhanced via a share feature 725. This enables a buyer or prospective buyer to forward, or share, the listing with another person or social media site to enhance visibility and increase traffic. By promoting the buying group and associated discount via the share feature 725, a wider mass of buyers can be reached ensuring that the group thresholds, as set by the seller, are met.

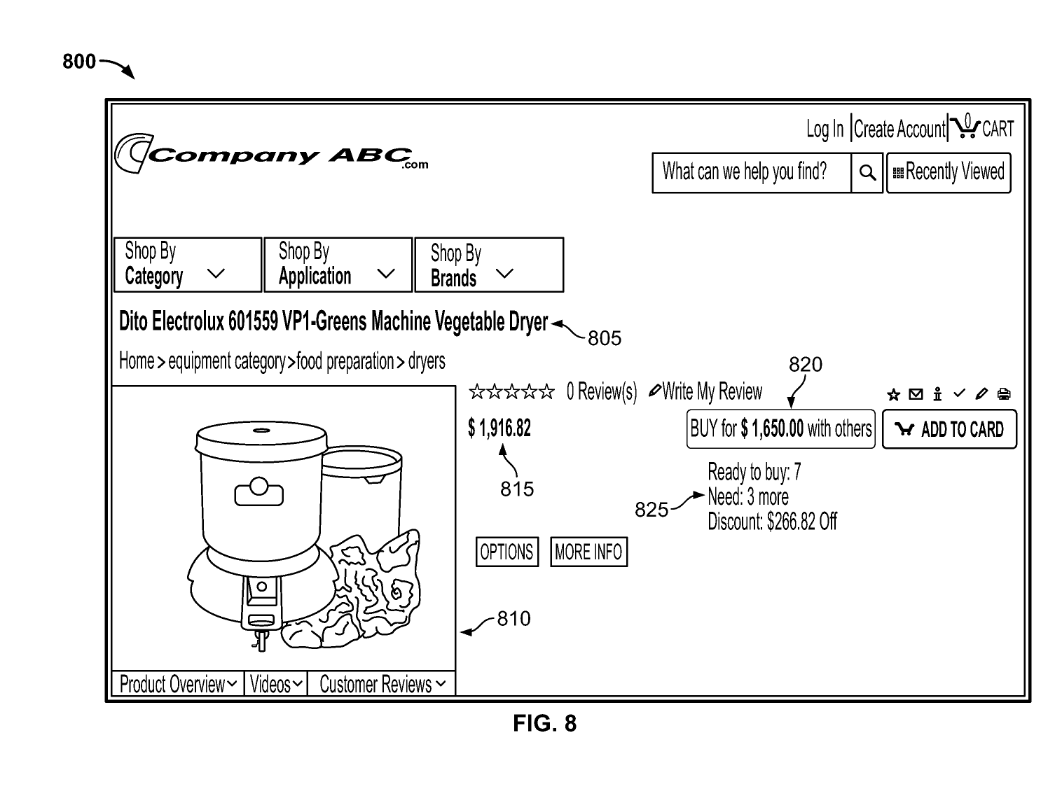

In FIG. 8, there is an example of a screen shot from a selling page 800 associated with a seller and the seller's products or services. Generally, there is a product description 805 which describes the make, model, type, year, or the like of the product or service being sold. A corresponding product or service image 810 provides a visual indicator as to the type of product being sold. The retail price 815 is the price the unit is being sold for on the selling page 800.

If the seller has listed the product or service with the APS, then a clickable button 820 will appear on the selling page 800. The clickable button 820, in this instance, features the phrase “buy for $xxxx.xx with others.” Below the clickable button 820 are statistics 825 which may include the number of committed buyers, the amount remaining to be sold, and the discount received by the buying group. By clicking the clickable button 820, the buyer becomes part of the buying group thereby receiving the product for the discounts price if the conditions of the group offer are met within the specified time period.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A computer implemented method performed via a processor for enabling at least one seller to create and manage at least one offer to sell products or services to a plurality of buyers for a discounted purchase price, the method comprising the steps of:
the seller obtaining an electronic client code generated by a processor from a sale promoter,
wherein the client code is placed on at least one electronic page where an offer to sell is being made,
wherein the client code enables electronic communication between the at least one electronic page and the sale promoter;
at least one of the plurality of buyers making an offer via a processor to purchase a product associated with the electronic client code;
wherein to make the offer the at least one buyer interacts with a graphical depiction of the client code and
wherein to make the offer the at least one buyer must be registered with the sale promoter;
comparing parameters of the offer with parameters implemented by the at least one seller;
wherein the parameters include at least a minimum number of products subject to purchase, an offer price, and an expiration date, and
wherein if the parameters of the offer meet the parameters implemented by the at least one seller then a sale is executed and if the parameters of the offer do not meet the parameters implemented by the at least one seller then the sale is not executed.

2. The method of claim 1 wherein upon execution of the sale the client code and offer are removed from the electronic page.

3. The method of claim 2 wherein the at least one seller can re-enable the offer through the sale promoter.

4. The method of claim 1 wherein upon execution of the sale the parameters for the sale are reset enabling the offer to continue.

5. The method of claim 1 further comprising the step of:
the sale promoter sharing information pertaining to the offer with any number of third parties.

6. The method of claim 1 wherein the offer from any of the plurality of buyers may be made on a selling page associated with the at least one seller or any other electronic page where the client code appears.

7. The method of claim 6 wherein the client code is displayed on an electronic page associated with the sale promoter.

8. A computer implemented method performed via a processor for enabling at least one seller to create and manage at least one offer to sell products or services to a plurality of buyers for a discounted purchase price, the method comprising the steps of:
the seller obtaining an electronic client code generated by a processor from a sale promoter,
wherein the client code is placed on at least one electronic page where an offer to sell is being made,
wherein the client code enables electronic communication between the at least one electronic page and the sale promoter;
the sale promoter sharing information pertaining to the offer with any number of third parties;
at least one of the plurality of buyers making an offer via a processor to purchase a product associated with the electronic client code;
wherein to make the offer the at least one buyer interacts with the client code and
wherein to make the offer the at least one buyer must be registered with the sale promoter;
comparing parameters of the offer with parameters implemented by the at least one seller;
wherein the parameters include at least a minimum number of products subject to purchase, an offer price, and an expiration date, and
wherein if the parameters of the offer meet the parameters implemented by the at least one seller then a sale is executed and if the parameters of the offer do not meet the parameters implemented by the at least one seller then the sale is not executed.

9. A non-transitory computer readable storage medium having embodied thereon computer executable instructions capable of being executed by at least one processor to perform a method comprising the steps of:
a seller obtaining an electronic client code generated by a processor from a sale promoter platform,
wherein the electronic client code is placed on at least one web page where an offer to sell is being made and is embodied as a graphical representation of a clickable button,
wherein the client code enables electronic communication with the sale promoter platform thereby enabling the seller to register new offers of sale and transmit information pertaining to existing offers;
at least one of a plurality of buyers making an offer to purchase via at least one processor to purchase a product associated with the electronic client code;
wherein to make the offer the at least one buyer must be registered with the sale promoter and
wherein the at least one buyer can rank other buyers who have made the same offer;
comparing parameters of the offer with parameters implemented by the at least one seller;
wherein the parameters include at least a minimum number of products subject to purchase, an offer price, and an expiration date, and
wherein if the parameters of the offer meet the parameters implemented by the at least one seller then a sale is executed and if the parameters of the offer do not meet the parameters implemented by the at least one seller then the sale is not executed.

10. The non-transitory computer readable storage medium of claim 9 further comprising the steps of:
at least one buyer creating an offer having a plurality of offer parameters;
the at least one buyer obtaining an offer certificate,
wherein the offer certificate becomes available when the offer parameters are met; and
contacting a seller with the offer certificate to complete the transaction.

11. The non-transitory computer readable storage medium of claim 9 wherein the offer to sell includes an image, textual description, video, or any combination thereof relating to the product or service subject to the offer to sell.

12. The non-transitory computer readable storage medium of claim 9 wherein the at least one buyer can withdraw the offer to purchase.

13. The non-transitory computer readable storage medium of claim 9 wherein the at least one buyer can commit to purchase more than one of the same or different products or services subject to the offer to sell.

14. A system comprising at least one processor communicatively coupled to at least one computer readable storage medium, whereby the at least one processor is programmed to implement a group purchasing platform, the system comprising:
an audiovisual display for displaying and communicating the desired content;
a computing device capable of being connected to a network;
a computer readable storage medium storing one or more programs for execution by the computing device;
and a processor operably coupled to the computing device, the processor configured to execute the steps of,
a seller obtaining an electronic client code generated by the processor from a sale promoter,
wherein the client code is placed on at least one electronic page where an offer to sell is being made,
wherein the client code enables electronic communication between the at least one electronic page and the sale promoter;
at least one of a plurality of buyers making an offer via the processor to purchase a product associated with the electronic client code;
wherein to make the offer the at least one buyer interacts with the client code and
wherein to make the offer the at least one buyer must be registered with the sale promoter;
comparing parameters of the offer with parameters implemented by the at least one seller;
wherein the parameters include at least a minimum number of products subject to purchase, an offer price, and an expiration date, and
wherein if the parameters of the offer meet the parameters implemented by the at least one seller then a sale is executed and if the parameters of the offer do not meet the parameters implemented by the at least one seller then the sale is not executed.

15. A computer implemented method performed via a processor for enabling at least one buyer to manage at least one offer to purchase products or services from at least one seller for a discounted purchase price, the method comprising the steps of:
the at least one buyer making an offer to purchase, via a processor, a product or service being sold with a corresponding electronic client code;
wherein to make the offer the at least one buyer interacts with a graphical depiction of the client code and
wherein to make the offer the at least one buyer must be registered with the sale promoter;
comparing parameters of the offer with parameters implemented by the at least one seller;
wherein the parameters include at least a minimum number of products subject to purchase, an offer price, and an expiration date, and wherein if the parameters of the offer meet the parameters implemented by the at least one seller then a sale is executed and if the parameters of the offer do not meet the parameters implemented by the at least one seller then the sale is not executed.

16. The method of claim 15 further comprising the steps of:
the at least one buyer creating an offer to purchase independent of any offers created by the at least one seller, the buyer created offer having a plurality of offer parameters;
the at least one buyer obtaining an offer certificate,
wherein the offer certificate becomes available when the offer parameters are met; and
contacting a seller with the offer certificate to complete the transaction.

17. The method of claim 16 wherein the offer certificate is a paper or electronic certificate containing an identifying code,
wherein the identifying code verifies a commitment to purchase multiple products or services by the at least one buyer.
